(19) United States
(12) Patent Application Publication
(10) Pub. No.: US 2010/0275590 A1
(43) Pub. Date: Nov. 4, 2010

(54) THERMOHYDRAULIC METHOD FOR INCREASING THE PRESSURE OF DIVERSE WORKING FLUIDS AND APPLICATION THEREOF

(76) Inventor: Wolfgang Harazim, Zwickau (DE)

Correspondence Address: JORDAN AND HAMBURG LLP, 122 EAST 42ND STREET, SUITE 4000, NEW YORK, NY, 10168, US

(21) Appl. No.: 12/734,760

(22) PCT Filed: Oct. 14, 2008
(86) PCT No.: PCT/DE2008/001671

§ 371 Date: Jul. 14, 2010

(30) Foreign Application Priority Data
Oct. 15, 2007 (DE) 10 2007 049 522.8

(51) Int. Cl. F02G 1/04; F02G 5/00

(52) U.S. Cl. 60/508

(57) ABSTRACT

A thermohydraulic pressure increase method and application thereof such as, required primarily in the field of energy management, in mechanical engineering, and in chemical plant engineering achieves volume change work by way of waste heat in a thermal process and applies the work to a hydraulic process, for example, in order to then drive presses or generators in stationary industrial systems. A hydraulic pump, which is driven by a motor disadvantageously requiring premiums forms of energy, such as electricity, diesel, or gasoline, is used conventionally to achieve the pressure increase. Some working fluids very drastically change the density thereof close to and above the critical point as the temperature rises, and transition into the gaseous state and under high pressure multiply the volume thereof if additional energy is supplied without density leaps at temperatures far below 100° C. If the substance-specific system pressure and the system temperature can be adjusted to a hydraulic process, the waste heat can be used for volume change work.

### BACKGROUND OF THE INVENTION

The invention relates to a thermohydraulic pressure increasing method, an apparatus and arrangement for practice of the method, and its application. A technical solution of this type is primarily required in the field of energy management, in engineering and chemical plant production.

In a conventional hydraulic system, the pressure increase is carried out by a hydraulic pump which is driven by a motor. For this purpose, high value energy sources are required, such as electricity, diesel or gasoline. Hydraulic system components are standard in the marketplace, are used everywhere in technology and are at a high level of development. However, use of high value energy drive sources is disadvantageous.

Some working fluids change their density very greatly near and above the critical point as the temperature increases and, if further energy is added, pass into the gaseous state, without jumps in density, at temperatures far below 100° C., and increase their volume multiple times at high pressure. If the material-specific system pressure and the system temperature can be adapted to a hydraulic process, the option is produced to use waste heat for the volume changing work.

It is therefore an object of the invention to achieve volume change work by means of waste heat in a thermal process, and to transfer this to a hydraulic process, in order to then drive, for example, presses or generators in stationary industrial plants.

### SUMMARY OF THE INVENTION

The object is achieved by a method which includes heating a liquid working fluid isochorically in a pressure container in a heat exchanger by flowing waste heat through the heat exchanger until a hydraulic working pressure is reached. The pressure container is communicative with an upper chamber of a double cylinder including a piston which partitions the upper chamber from a lower chamber in which hydraulic oil is provided, thereby separating the working fluid and hydraulic oil in the double cylinder. The method further includes controlling a suction valve and a pressure valve in communication with the lower chamber by differential pressure in a hydraulic oil system also in communication with the suction and pressure valves, and expelling the hydraulic oil from the lower chamber after the hydraulic working pressure is reached by downward movement of the piston from an initial position, such that continued heating takes place isobarically until a lower dead stop is reached by the piston. The piston is then displaced to the initial position, during a subsequent cooling phase, by a reduction in volume and low pressure of the hydraulic oil system.

### BRIEF DESCRIPTION OF THE DRAWINGS

FIG. 1 is a schematic view of a heat exchanger assembly comprised of a heat exchanger, a double cylinder, and pressure and suction valves, for implementation of a method according to the invention;

FIG. 2 is a schematic diagram depicting an example of a hydraulic switching arrangement for the hydraulic oil used to implement the method according to the invention; and

FIG. 3 is a schematic diagram depicting an example of a thermal switching arrangement for the waste heat medium used to heat the working fluid in each of the heat exchangers.

### DETAILED DESCRIPTION OF THE INVENTION

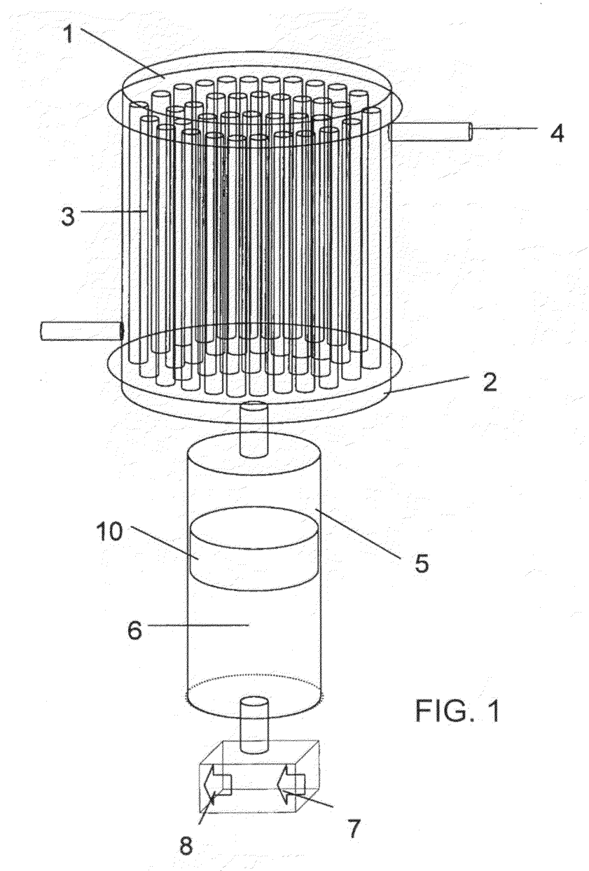

An embodiment of an apparatus and arrangement for carrying out the method according to the invention is described, with reference to FIGS. 1-3.

A thermohydraulic cylinder assembly, as shown for example in FIG. 1, comprises a heat exchanger 3, a double cylinder 5, a suction valve 7 and a pressure valve 8. A working fluid 1 is provided in a pressure container 2 of the heat exchanger 3. The heat exchanger 3 further includes an inlet and an outlet for introduction and discharge, respectively, of waste heat 4 for heating of a working fluid partitioned from the waste heat 4 within the heat exchanger 3. A piston 10 is disposed within the double cylinder, thereby partitioning an upper chamber from a lower chamber. The pressure container 2 is in communication with the upper chamber of the double cylinder 5, and the piston 10 separates the working fluid 1 in the upper chamber of the double cylinder 5 from hydraulic oil 6 provided in the lower chamber of the double cylinder 5.

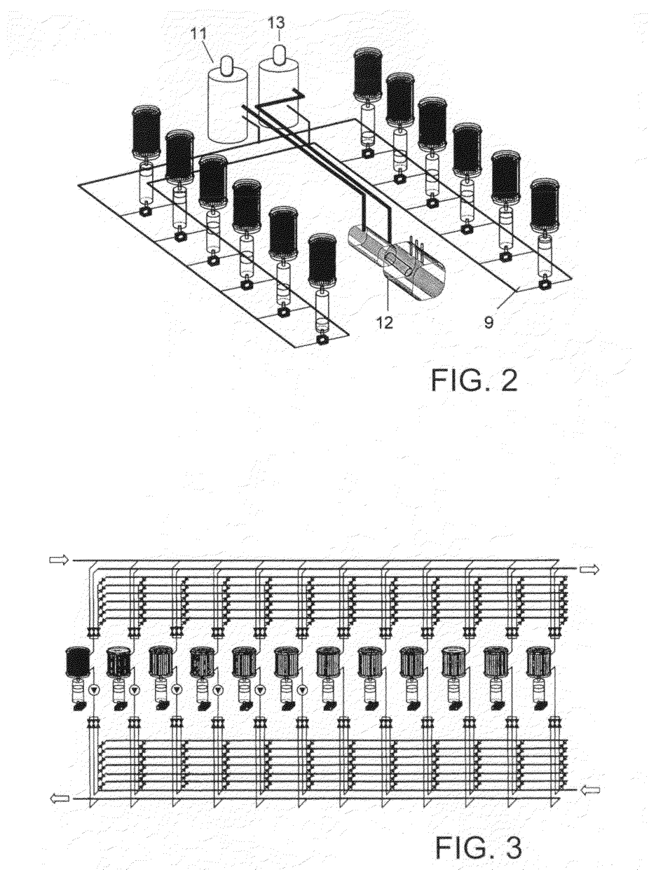

The thermohydraulic cylinder assembly further includes a suction valve 7 and a pressure valve 8 which are controlled by the differential pressure in a hydraulic oil system 9 (see FIG. 2).

In carrying out the method according to the invention, the liquid working fluid 1 is heated isochorically at the start of a cycle by means of the heat exchanger 3 in the pressure container 2, resulting in a rise in pressure and temperature.

At the start of the cycle, the piston 10 is at the top (high density). The pressure valve 8 does not open until the internal pressure in the pressure container 2 and the upper chamber of the double cylinder 5 rises above the hydraulic pressure. Hydraulic oil 6 then flows into a high pressure container 11 (see FIG. 2) and can be used for work (for example, driving a hydraulic motor with a generator 12, as also depicted in FIG. 2).

After the pressure valve 8 has opened, the further heating of the working fluid takes places isobarically (upper hydraulic pressure) until the bottom dead center in the double cylinder 5 is reached (low density). As cooling takes place, the volume is reduced again, the pressure drops and the low pressure of the hydraulic system (stored, for example, in a low pressure hydraulic oil container 13, as shown in FIG. 2) pushes the piston 10 back again into the upper initial position. Since the heating and cooling of the working fluid takes place in a constantly rising and falling manner, respectively, a large part of the heat can be regenerated.

FIGS. 2 and 3 illustrate one possible application, where, for example, twelve of the thermohydraulic assemblies, as depicted in FIG. 1 (each comprised of heat exchanger 3, double cylinder 5 and pressure and suction valves 7, 8), are connected together. Here, these thermohydraulic cylinder assemblies 3,5,7,8 are connected in two groups of six, each for regeneration in one cycle; i.e., one is heated and one is cooled.

The connection assignment changes for the next cycle by means of regulation, with the result that one complete stroke can be sucked in and pressed out per cycle.

1.-4. (canceled)

5. A method of increasing the pressure thermohydraulically, comprising:
heating a liquid working fluid isochorically in a pressure container in a heat exchanger by flowing waste heat through the heat exchanger until a hydraulic working pressure is reached, said pressure container being communicative with an upper chamber of a double cylinder, said double cylinder including a piston which partitions the upper chamber from a lower chamber in which hydraulic oil is provided, thereby separating the working fluid and hydraulic oil in the double cylinder;
controlling a suction valve and a pressure valve in communication with the lower chamber by differential pressure in a hydraulic oil system also in communication with the suction and pressure valves;
expelling the hydraulic oil from the lower chamber after the hydraulic working pressure is reached by downward movement of the piston from an initial position such that continued heating takes place isobarically until a lower dead stop is reached by the piston; and
displacing the piston to the initial position, during a subsequent cooling phase, by a reduction in volume and low pressure of the hydraulic oil system.

6. A method according to claim 5, further comprising repeating cycles of said heating, controlling, expelling and displacing.

7. A method according to claim 5, wherein the heat exchanger and the double cylinder are arranged vertically, in order to achieve an optimum thermal stratification during the mass displacement.

8. A method according to claim 5, wherein an assembly comprised of said heat exchanger and said double cylinder is insulated completely.

9. A method according to claim 7, wherein an assembly comprised of said heat exchanger and said double cylinder is insulated completely.

10. A method according to claim 5, wherein efficiency is optimized by carrying out the method in multiple stages with regeneration.

11. A method of increasing the pressure thermohydraulically, comprising:
heating a working fluid isochorically in a pressure container in a heat exchanger by flowing waste heat through the heat exchanger until a hydraulic working pressure is reached;
controlling a suction valve and a pressure valve in communication with the pressure container by differential pressure in a hydraulic system containing the working fluid also in communication with the suction and pressure valves; and
expelling the working fluid after the hydraulic working pressure is reached such that continued heating takes place isobarically.

12. A thermohydraulic cylinder assembly for converting waste heat into hydraulic energy, comprising:
a heat exchanger including an inlet and an outlet for introduction and discharge, respectively, of waste heat for heating of a working fluid partitioned from the waste heat within the heat exchanger within a pressure chamber;
a double cylinder including a piston disposed within the double cylinder, thereby partitioning an upper chamber from a lower chamber, the pressure container being in communication with the upper chamber of the double cylinder, the piston separating the working fluid in the upper chamber of the double cylinder from hydraulic oil provided in the lower chamber of the double cylinder; and
a suction valve and a pressure valve in communication with the lower chamber of the double cylinder which are controllable by differential pressure in a hydraulic oil system also in communication with the suction and pressure valves.
